(19) United States
(12) Patent Application Publication
(10) Pub. No.: US 2009/0092823 A1
(43) Pub. Date: Apr. 9, 2009

(54) Braze-metal coated articles and process for making same

(75) Inventors: Steven W. Webb, Worthington, OH (US); Gaurav Aggarwal, Columbus, OH (US)

Correspondence Address: Diamond Innovations, 6325 Huntley Road, Worthington, OH, 43229, US

(73) Assignee: Diamond Innovations, Inc., Worthington, OH (US)

(21) Appl. No.: 12/287,123

(22) Filed: Oct. 6, 2008

Related U.S. Application Data
(60) Provisional application No. 60/977,694, filed on Oct. 5, 2007.

(51) Int. Cl. B32B 15/04; B05D 3/00; B32B 5/16

(52) U.S. Cl. 428/323; 428/457; 427/191; 427/192

(57) ABSTRACT

In one embodiment, a carbide-containing article includes a carbide body with an attached optional superabrasive layer. A braze metal coating is attached to a surface the carbide substrate. The coating primarily is made of particles of a metal having a melting point of less than 1200° C., the particles having a size of less than 0.1 mm. In another embodiment, a process for applying a braze metal coating to a carbide body of a superabrasive or other article includes depositing finely divided particles of a low melting point metal onto the carbide body by spraying the particles and gas onto the body at a velocity that is between 500 km/sec and 2 km/sec, with volumetric delivery of the particles being less than 50 grams per minute.

### CROSS REFERENCE TO RELATED APPLICATIONS

This patent application claims priority to co-pending U.S. Provisional Patent Application No. 60/977,694, filed Oct. 5, 2007, the disclosure of which is incorporated herein by reference in its entirety.

Not Applicable

### BACKGROUND

1. Technical Field

The embodiments described herein are generally directed to coated articles, such as superabrasive articles, and processes for braze-metal coating a carbide-containing article, such as the carbide substrate of a superabrasive article. Embodiments are also directed to methods for using cold spray or kinetic metallization for coating a carbide-containing cutting element or other tool with a braze metal.

2. Related Art

Fabrication of metal cutting and shaping tools such as superabrasive tools generally requires that polycrystalline diamond (PCD) or polycrystalline-cubic boron nitride (PCBN) materials or blanks be cut by electrical discharge machining (EDM) into small precision-shaped pieces and brazed onto tool holders. Many PCD and PCBN materials are supplied with a diffusion-bonded carbide substrate layer that is positioned on one surface or one side of the PCD or PCBN material. The carbide and PCD or PCBN blanks are generally cut into a tip using EDM or another process. A braze filler metal is applied to the carbide surface of each tip, and then high-temperature brazing is conducted to attach the tip to a tool, such as a drill, saw or other device. It is desirable to bond or attach a braze metal layer to the carbide side of a superabrasive blank so that toolmakers do not have to custom cut and temporarily fix (glue, clamp, hold manually) braze metal foils prior to brazing the tips to their tools. This is especially convenient when the toolmaker must produce hundreds of identical tools or a small number of differently shaped tips.

To apply a braze metal layer to a PCD or PCBN tip, a user must cut braze metal foils and attach the braze metal foil to the carbide side of each PCD or PCBN tip using an adhesive. Alternatively, the user may otherwise fix the cut foils to the carbide surface of each PCD or PCBN tip. This process is complicated, labor intensive and requires a great deal of time, thereby increasing the cost of tool manufacture. The temporary attachment may fail during heatup, prior to melt, of the clamped tool/tip/braze metal system, causing the tip to be misplaced on the tool or to fall off of the tool.

The application-of a braze metal to carbide-coated PCD and PCBN does not exist. The carbide is typically less than 30 percent metal, so it is difficult to create a bond between a braze metal and the carbide side of the PCD or PCBN article that can survive EDM cutting and routine handling. Simple cold adhesives or solders do not work, because they degrade or melt during EDM.

High-quality diffusion bonded metal films exist. However, these products are prohibitively expensive, as high pressure and high temperature (HPHT) is required to form the diffusion bonded metal film. This can introduce irregularities such as cracks and chips into the PCD or PCBN portion of the material or article. Diffusion bonded metal films can be put on small (<5 mm) cut tips, without the need for high pressure. However, this is inconvenient, inflexible, labor-intensive and slow, as the tips must first be cut to a particular shape, braze foil or paste must be applied to each small tip individually, and then each tip must be heated individually or in individual containers.

Currently, adherent braze metal is applied to PCBN tips that are less than about 5 mm thick by furnace brazing (see, for example, U.S. Patent Publication No. 2004/0155096A1). This process includes the steps of coating pre-EDM cut PCBN tips with braze metal paste made of a metal powder and a resin, placing coated tips into individual graphite cavities in graphite trays, and firing the trays in a furnace. However, this process cannot be used for coating PCD or PCBN parts that are greater than 5 mm thick due to thermal stress, delamination of the PCD or PCBN and the carbide, and the formation of cracks in the carbide, the superabrasive material or both.

Prior attempts to apply a weldable metal layer to a superabrasive insert include those described in International Patent Application No. PCT/US2006/031333. However, the methods described in that document require the use of heated gases, and are limited to metal layers that can withstand high heats. The hot process produces undesirable finished tool quality. Other hot methods of coating PCD and PCBN materials have been attempted and include electro-spark coating (see, for example, U.S. Pat. No. 5,102,031) and high velocity oxygen fuel (HVOF) spray coating (see, for example, U.S. Patent Publication No. 2001/0001042A1). However, the braze layers produced by this method are not high quality because the application of bulk molten metal to the carbide-side of the PCD or PCBN causes the superabrasive material to overheat, thereby reducing its overall hardness. Also, a bulk melt coating tends to cause cracking or contraction of the braze metal layer during cooling causing delamination. Coating with molten metal fluids is difficult since wetting of carbide by most fluid metals is un favorable, causing the fluid film to coalesce, reducing the coating coverage and/or thickness regularity.

Accordingly, there is a need for a process for applying a braze metal to the carbide substrate of a superabrasive tip that avoids thermal cracking while producing a tough, adherent, uniform braze metal film on the carbide-side of the superabrasive object.

### SUMMARY

Embodiments provided herein are generally directed to braze metal coating for carbide, braze metal coating for carbide coated PCD and PCBN materials and methods for applying a braze metal coating to carbide or carbide coated PCD and PCBN materials. In various embodiments, the braze metal may be deposited onto a surface of a carbide article, or a carbide substrate of a PCD or PCBN article, by a cold metallization process such as, but not limited to, kinetic metallization, cold spray metallization, electromagnetic particle acceleration, modified high velocity air fuel spraying or high velocity impact fusion.

In an embodiment, a superabrasive article includes a superabrasive layer and a carbide substrate attached to the superabrasive layer. Optionally, the carbide substrate may be treated by itself using the processes described in this disclosure. The carbide substrate has a metal content of less than 30 volume-% metal. A braze metal coating is attached to a surface the carbide substrate. The coating primarily is made of a metal having a melting point of less than 1200° C., such as copper, silver, zinc, tin, bismuth, lead or the like or any combinations or alloys thereof. The coating may be made of particles of the metal, each of the particles having a size of less than 0.1 mm. Optionally, the coating may include a small (e.g., less than 5 percent or less than 4 percent) amount of metal particles having a higher melting point, such as titanium. Optionally, the article also may include a flux layer over the braze metal coating, such as a flux layer of borax powder.

In another embodiment, a method for applying a braze metal coating to a carbide-containing article includes depositing particles of a metal having a melting point of less than 1200° C. onto a surface of the carbide by kinetic metallization. The method also may include texturing the carbide and pre-heating the metal particles prior to the depositing. The depositing may include feeding the metal particles and a gas into a spray nozzle and directing the metal particles and gas onto the substrate through the spray nozzle. Optionally, directing may include spraying the particles and gas onto the substrate at a velocity that is between 500 km/sec and 2 km/sec, with volumetric delivery of the particles being less than 50 grams per minute.

In another embodiment, a process for preparing a superabrasive blank includes applying a superabrasive layer to a carbide substrate, the carbide substrate comprising between about 2 volume-% and about 30 volume-% metal; depositing a coating of a braze metal onto the carbide substrate by a cold metallization process; and after the depositing, cutting a blank from the coated, brazed article. The cold metallization process may include, for example, kinetic metallization, cold spray metallization, electromagnetic particle acceleration, modified high velocity air fuel spraying or high velocity impact fusion. The depositing may include feeding finely divided (5 μm to 100 μm) copper or other metal powder and air or another gas into a spray nozzle, and directing the metal powder and gas onto the substrate through the spray nozzle. Optionally, the directing may include spraying the powder and gas onto the substrate at a velocity that is between 500 km/sec and 2 km/sec, with volumetric delivery of the particles being less than 50 grams per minute.

### BRIEF DESCRIPTION OF THE DRAWINGS

FIG. 1 illustrates exemplary steps in a process of creating a braze metal-coated tool;

FIG. 2 illustrates an exemplary superabrasive tool as it receives a braze metal coating;

FIG. 3 illustrates a coating applied to a PCD blank according to the present invention; and

FIG. 4 illustrates the absence of cracks or delamination of an exemplary coating applied according to the present invention.

### DETAILED DESCRIPTION

Before the present embodiments are described, it is to be understood that this invention is not limited to the particular systems, methodologies or protocols described, as these may vary. Also, the terminology used herein is for the purpose of describing particular embodiments and is not intended to limit the scope of the present disclosure, which will be limited only by the appended claims.

As used in this description and in the appended claims, the singular forms “a,” “an,” and “the” include the plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

As used in this document, the term “braze metal” means any material, film or layer that acts as a bonding film or layer between a carbide substrate of a superabrasive insert or blank and the tool that holds the insert or blank. The bond is mainly adhesive in nature, formed by the process commonly known as “brazing”, which typically involves heating the braze metal to melt, allowing the melt to spread via capillary or pressure forces, then freezing the melt to form an adhesive film bonding the tool and the tip. The adhesive film or layer is typically a metal or metal alloy having a thickness of 0.0001 inches to 0.010 inches or more, or 0.05 mm to about 1.2 mm, with a melting point of 400° C. to 1200° C. The braze metal layer may or may not react with the superabrasive tip, substrate, or article, and it is typically resistant to oxidation.

As used in this document, the term “cold metallization” refers to any process by which metal may be deposited onto a substrate without significantly heating either the metal or the substrate. “Without significantly heating” means that the metal does not melt, and optionally that the maximum temperature of the carbide is always less than 300° C. for any non-instantaneous period of time. Examples of cold metallization processes include, and are not limited to, kinetic metallization, cold spray metallization, electromagnetic particle acceleration, modified high velocity air fuel spraying, high velocity impact fusion or the like or a similar process in which non-melted metal particles are deposited onto the surface of the carbide substrate by spraying the particles at high speed. The particles may be preheated below their melting point, such as up to 500° C. or more.

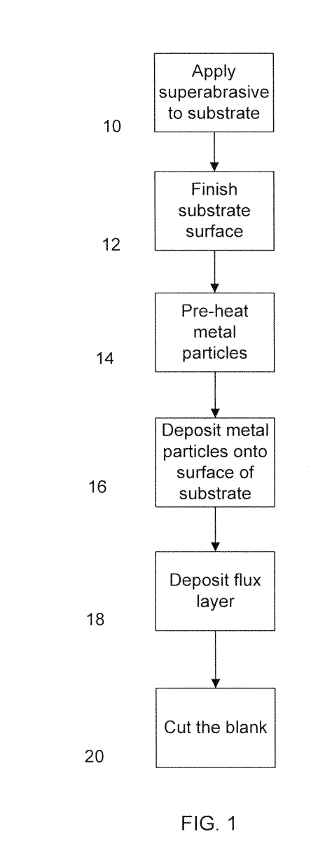

In some embodiments, a process for depositing a braze metal coating onto a carbide article, such as a tungsten carbide tool, or the carbide substrate of a PCD or PCBN cutting element, includes using cold metallization, such as kinetic metallization, cold spray metallization, electromagnetic particle acceleration, modified high velocity air fuel spraying, high velocity impact fusion and the like to deposit the braze metal onto the substrate. For example, referring to FIG. 1, a method may include the steps of applying a superabrasive material PCD or PCBN to one side of a carbide substrate (step 10) using, for example, diffusion bonding or high pressure high temperature processing methods known to those of skill in the art. The method then includes depositing (step 16) a braze metal coating onto the carbide surface by cold metallization (step 16). Alternatively, the method may involve depositing a cermet layer directly onto a superabrasive layer by cold spraying.

In some embodiments, a flux layer (step 18) may be sprayed onto the braze metal layer using a similar cold metallization process. The flux layer may include materials such as borax powders.

In some embodiments, such methods may further include the step of cutting (step 20) the object after the carbide is braze metal coated using, for example, electrical discharge machining (EDM). In certain embodiments, the braze metal coated carbide and PCD or PCBN material may be cut into a blank, a tool, a tip cutting element or other such article (step 20). In other embodiments, the process may include the step of finishing (step 12) at least a portion of the surface of the carbide substrate prior to applying a braze metal layer to roughen (or alternatively smooth) the substrate by, for example, grinding.

The process of kinetic metallization generally involves spraying non-melted, finely divided low melting point metal powder or a mixture of finely divided low melting point metal powders onto a surface at high velocity, typically greater than 500 m/sec. In various embodiments of such methods, the finely divided low melting point metal powder or mixture of finely divided low melting point metal powders, ceramic or resin powders, are mixed with a gas or gas mixtures such as air, nitrogen, helium or hydrogen, and sprayed at a high-velocity (i.e., from 500 m/sec up to 2 km/sec) and caused to decelerate when the particles strike a surface of a substrate. The substrate may be held at any temperature from −40° C. up to ⅔^{rd} of the melting point of the particles, but typically is at 20-30° C. The substrate may be cooled, heated, or allowed to remain at ambient temperature.

The metal powder is primary made of a low melting point metal (i.e., a metal having a melting point less than 1200° C.). In some embodiments, the metal powder may include, but is limited to, copper, silver, zinc, tin, aluminum, bismuth, lead or the like or any combinations or alloys thereof. Optionally, the metal powder may include small (e.g., less than 5 percent or less than percent) of a higher melting point metal such as titanium.

In most applications, the carbide substrate on to which the metal particles are deposited is a carbide substrate made primarily of a ceramic material. For example, the substrate may include tungsten carbide containing approximately 12 percent metal.

During the process of applying the braze metal layer, the metal particles may collide with the surface of the substrate. The particles may be heated (step 14) either before application or via friction (internal and external) from the spray process or other processes up to but not over the melting point of the particles. In some embodiments, the metal particles may not be heated at all, and may instead bind to the substrate because of the force of the collision alone. The particles are mixed with a gas and, when applied, undergo viscous flow and spreading and then rapidly quench and solidify to form a solid film over the substrate as the friction heat is dissipated into the superabrasive article. Optionally, the gas may simply be available ambient air, delivered at ambient or room temperature without additional heating or cooling beyond that which may have occurred from ordinary building climate control systems. Pressures of delivery may be, for example, 40 psi and 500 psi. Although the velocity of delivery may be high (e.g., 500 m/sec to 1500 m/sec, or 500 m/sec to 2000 m/sec), the volumetric delivery rate of particles may be very low (typically less than 50 grams per minute). Thus, the friction and heat flux may be less than about 150 watts onto less than 2 mm² of contact area (i.e., less than 75 W/mm², assuming zero spray traverse rate). The heat of the particles is quickly dissipated by the superabrasive/carbide article so that the article never overheats over 300° C.

Prior to application, the non-melted particles may be friction-heated and stressed to cause large-strain plastic flow. It is this large-strain plastic flow that generates adhesion of the particles to the substrate surface and between particles. If the particles resist plastic flow, they will not stick and the coating will not build. Plastic flow typically requires that a temperature of about ⅔ the melting point be attained on the surface during coating for a sufficient duration to allow deformation to occur. If the particles are too hard, they will abrade the coating formed, reducing the efficiency of the process.

It is helpful to pre-strain, alloy, cold-work, anneal or preheat the particles prior to spraying them to reduce their hardness and resistance to high-strain and high strain-rate (less than 2 km/sec) plastic deformation engaged in the cold spray process.

Any carbide material now or hereafter known in the art may be coated using the method described herein. In some embodiments, the carbide substrate of a superabrasive tool may contain a ceramic material and a metal matrix material in which the metal matrix material makes up less than about 30 percent by volume (volume-%) of the total carbide composition. In other embodiments, the metal matrix material may make up less than any of the following: about 25 volume-%, 20 volume-%, 15 volume-%, 10 volume-%, 9 volume-%, 8 volume-%, 7 volume-%, 6 volume-%, or 5 volume-% of the carbide. In still other embodiments, the metal matrix material may make up from about 30 volume-% to about 2 volume-%, about 25 volume-% to about 2 volume-%, about 15 volume-% to about 2 volume-%, about 10 volume-% to about 2 volume-%, or about 5 volume-% to about 2 volume-% of the carbide.

The ceramic portion of the carbide material may be, and is not limited to, molybdenum carbide, chromium carbide, tungsten carbide, iron carbide and the like. For example, in one embodiment, tungsten carbide having about 2 volume-% to about 5 volume-% metal is used. A metal matrix may serve as an additional binding or cementing material. For example, particles of a carbide material may be cemented with a metal matrix of an iron group metal such as iron, nickel, chromium, molybdenum or cobalt. For example, in one embodiment, tungsten carbide may incorporate cobalt as a cementing metal matrix material.

It is helpful if the surface is textured to increase its surface area prior to coating. This gives more surface area for the deforming, friction-heated particles to adhere to prior to cooling.

The braze material applied herein may have a finely divided, low melting point material. As used herein, “finely divided” means a material having a particle size of less than 0.1 mm, optionally less than 0.08 mm, or optionally between 0.06 mm and 0.04 mm. Optionally, the particles may vary between 5 μm and 100 μm. “Low melting point” means having a melting point less than 1200° C., optionally less than 1000° C. The material may also comprise ceramic and/or resinous elements, commonly associated with cermets such as tungsten carbide/cobalt or braze flux materials, such as borax powders. Thus, unlike prior art application methods, the particles are neither melted nor significantly agglomerated, allowing for improved adhesion and less stress on the substrate.

The braze film or layer may comprise a single layer of braze metal, or multiple layers, in any stacking arrangement. Those layers may comprise layers of resin/ceramic material with layers of metal or layers of ceramic/metal in any pattern.

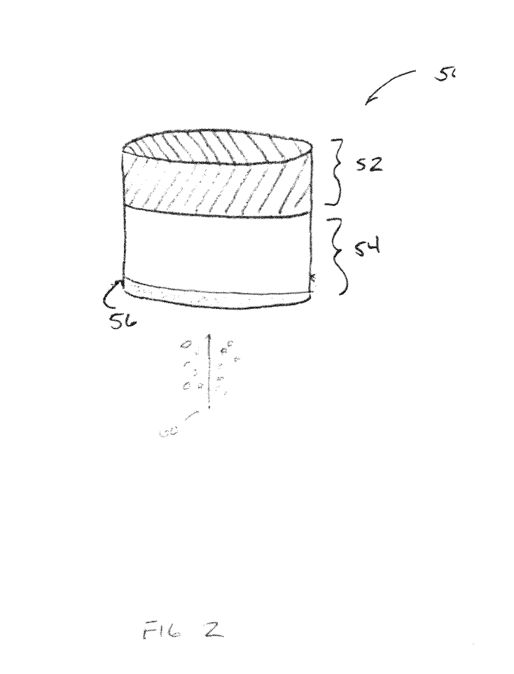

Referring to FIG. 2, a superabrasive tool 50 includes a superabrasive layer 52 and carbide substrate 54. Some or all of the exterior surfaces 56 of the substrate may receive the coating of metal powder particles 60. The particles are of a finely divided size, and primarily comprise a low melting point metal such as copper, silver, zinc, tin, aluminum, bismuth, lead or the like or any combinations or alloys of any of the foregoing. In some embodiments, the braze metal layer is primarily comprised of a low melting point metal, and it does not include any higher melting point (over 1200° C.) metals in any significant amounts.

The examples and methods described herein may also apply to cemented carbide articles. Cemented carbides contain refractory metal carbides, such as tungsten, titanium, or vanadium carbides and a metallic binder phase.

The method described herein does not require the application of a fixing agent, such as an adhesive, nor does it require the presence of diffusion bonded metal, to the surface of the carbide substrate to which the braze metal particles will be deposited. Thus, in various embodiments the method may only include depositing a braze metal onto the carbide surface of a superabrasive cutting element. In various other embodiments, the method may further include the step of smoothing or roughening or texturing the carbide surface without the addition of any other material to the carbide surface prior to depositing the braze metal to the carbide. In one embodiment, the surface of the carbide is smoothed by grinding. In another embodiment, the surface is textured via grit blasting.

The use of kinetic metallization in the process of the embodiment described above may allow for a braze metal coating to be applied to a carbide surface of a superabrasive article without the use of an adhesive, without excessive heating of the PCD or PCBN layer and without diminishing the integrity of carbide coating or the PCD or PCBN layer. In some embodiments, heat required to form the braze metal coating may not accumulate in the PCD or PCBN layer of carbide coated PCD or PCBN materials and may, instead, dissipate through the metal film and/or the carbide coating. Therefore, the methods of some embodiments may avoid bulk heating and/or contraction of the PCD or PCBN layer, the carbide layer and/or the braze metal film while achieving sufficient localized temperature for the metal to fuse, flow and crystallize against the surface of the carbide layer.

The kinetic metallization process may be modified to achieve a uniform braze metal coating. For example, the use of an inert gas propellant may prevent oxidation that may increase melt viscosity and decrease surface flow and adhesion of the braze-metal. Since the cold spray process uses a lot of gas, air is preferred. A low atomic weight, such as H₂ or helium, also may be used such that limited gas pressure creates more acceleration and higher particle velocity. Additionally, the solid particles may be adjusted for shape and size to improve their acceleration in the gas flow. Additionally, variability in the velocity and deceleration of the metal powder particles, which may relate to gas/solid mixture ratio, the pressure of the gas propellant, and/or the particle size of the metal powder, may effect the metal coating. Moreover, the metal particles may not flow and or adhere well to the carbide surface if friction heat is too low such that transient maximum surface temperature of the decelerated particles is less than about ⅔ of the melting point, and if friction heat is too high, the metal particles may not adhere well because they may recoil, splash or vaporize or coalesce on the surface. Excessive heat may also damage the carbide or the PCD or PCBN layer of the material. Thus, it may be desirable to adjust the kinetic spray accordingly to provide good adhesion of the braze metal without the negative effects associated with over heating or under heating the particles. This is typically done by controlling the gas pressure and converging/diverging nozzle geometry, as well as distance of spray nozzle to surface.

### EXAMPLE 1

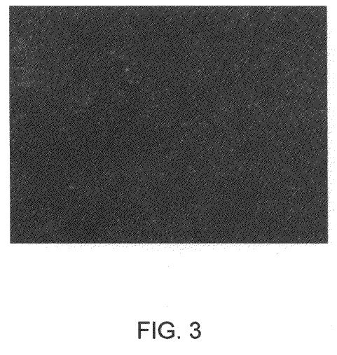

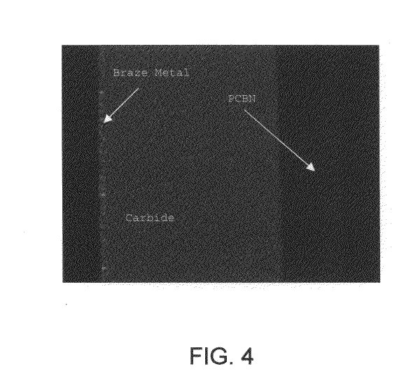

PCBN blanks were coated with copper powder using kinetic metallization. Kinetic metallization took place under the following conditions: 16 μm copper powder was fed at 20 g/min into the spray nozzle having a nozzle throat diameter 2 mm and the powder was mixed with 500° C. preheated N₂ gas at a pressure of 350 psi. The resulting spray had a particle velocity of greater than 610 m/sec. The spray was directed across the PCBN blank (carbide side up) at 50 mm/sec traverse, 2 mm steps and 8 mm of overspray to cover the PCBN blank. The coating process was about 20% efficient. (In other words, about 80% of metal did not fuse or adhere and was recycled). The resulting copper film was uniformly from 0.1 mm to 0.15 mm thick, with visually uniform roughness and color across the 58 mm outer diameter blanks as illustrated in FIG. 4 (ground-section of the coating, side view) and FIG. 3 (top view, showing copper- and green copper-oxide coating). As seen in FIGS. 3 and 4, the coatings were delamination and crack-free. All coatings adhered to the carbide well and were able to remain attached to the carbide after adhesive tape was pressed onto the brazed-metal surface and then removed. Furthermore, when the cold-spray copper-coated PCBN blank was cut using EDM, the coating did not delaminate or crack during EDM as shown in the EDM-cut edges shown in FIG. 3.

### EXAMPLE 2

CuZnSn (33:33:33) pre-alloyed powder of melting point 670° C. and 63 μm particle size was sprayed at 900 m/sec in air at the ground and at the grit-blasted (90 grit SiC) carbide surface of PCD blanks. The alloy coating adhered well and built up to 0.08 mm of coating thickness. The CuZnSn coating survived EDM cutting with no spalling or delamination as shown in FIG. 4. However, the coating showed spalling in laser cutting. The coating on the EDM-cut parts was tested in standard induction brazing, using conventional flux and methods. It produced a bond of reasonable joint strength.

### EXAMPLE 3

The metal powder of Example 2 above was sprayed at 900 m/sec in air directly at the lapped PCD surface of a superabrasive blank. The metal stuck well and built to 0.1 mm thickness on the PCD.

### EXAMPLE 4

The metal powder of Example 2 above was cold sprayed at 900 m/sec in air onto the surface of grade HTM superabrasive blank. The coating adhered well and built up to 1 mm of thickness. The cross-section of the coating revealed no delaminations.

It will be appreciated that several of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

We claim:

1. A superabrasive article, comprising
a superabrasive layer;
a carbide substrate attached to the superabrasive layer, the carbide substrate having a metal content of less than 30 volume-% metal; and
a braze metal coating attached to a surface the carbide substrate, the coating primarily comprising a low melting point metal.

2. The article of claim 1, wherein the coating comprises particles of the low melting point metal, each of the particles having a size of less than 0.1 mm.

3. The article of claim 2, wherein the metal has a melting point of less than 1200° C.

4. The article of claim 2, wherein the non- metal comprises silver, tin, bismuth, lead, or an alloy of silver, tin, bismuth, or lead.

5. The article of claim 2, wherein the metal comprises copper or an alloy of copper.

6. The article of claim 1, further comprising a flux layer over the braze metal coating, the flux layer comprising borax powder.

7. A method for applying a braze metal coating to a tungsten carbide surface, the substrate having a metal content of less than about 30 volume-% comprising:
depositing metal particles having a melting point of less than 1200° C. onto a tungsten carbide surface by kinetic metallization.

8. The method of claim 7, further comprising, before the depositing:
texturing the tungsten carbide surface; and
pre-heating the metal particles to a temperature up to 500° C.

9. The method of claim 7, wherein the depositing comprises:
feeding the metal particles and a gas into a spray nozzle; and
directing the metal particles and gas onto the substrate through the spray nozzle.

10. The method of claim 9, wherein the directing comprises spraying the particles and gas onto the substrate at a velocity that is between 500 km/sec and 2 km/sec, with volumetric delivery of the particles being less than 50 grams per minute.

11. A process for preparing a superabrasive blank, comprising;
applying a superabrasive layer to a carbide substrate, the carbide substrate comprising between about 2 volume-% and about 30 volume-% metal;
depositing a coating of a braze metal onto the carbide substrate by a cold metallization process; and
after the depositing, cutting a blank from the coated, brazed article.

12. The process of claim 11, wherein the cold metallization process comprises kinetic metallization, cold spray metallization, electromagnetic particle acceleration, modified high velocity air fuel spraying or high velocity impact fusion.

13. The process of claim 11, wherein the depositing comprises:
feeding metal powder and a gas into a spray nozzle; and
directing the metal powder and gas onto the substrate through the spray nozzle.

14. The method of claim 11, wherein the directing comprises spraying the powder and gas onto the substrate at a velocity that is between 500 km/sec and 2 km/sec, with volumetric delivery of the particles being less than 50 grams per minute.

15. The method of claim 13, wherein the metal powder comprises finely divided copper particles.

16. The method of claim 13, wherein the metal powder has an average particle size of between 5 μm and 100 μm.

17. The method of claim 13, wherein the gas comprises room temperature air.

18. The method of claim 11, further comprising preparing the gas by preheating the gas to a temperature of between 23° C. and 500° C.

19. The method of claim 11, further comprising preparing the powder by preheating the powder to level above ambient temperature and below 1200° C.

20. The method of claim 11 wherein the direction comprises directing the gas and powder through the nozzle at a pressure of between 40 psi and 500 psi and a particle velocity of between 500 m/sec and 1500 m/sec.
